(19) United States
(12) Patent Application Publication
(10) Pub. No.: US 2007/0155201 A1
(43) Pub. Date: Jul. 5, 2007

(54) PCB edge connector

(75) Inventors: Harold Ellison, Huntington Beach, CA (US); Richard M. Andrews, Lake Forest, CA (US)

Correspondence Address: LAW OFFICE OF MARK J. SPOLYAR, 2200 CESAR CHAVEZ STREET, SUITE 8, SAN FRANCISCO, CA, 94124, US

(73) Assignee: Quantum Corporation, a Delaware Corporation

(21) Appl. No.: 11/326,988

(22) Filed: Jan. 5, 2006

(51) Int. Cl. H01R 12/00

(52) U.S. Cl. 439/79

(57) ABSTRACT

An exemplary embodiment provides for an electrical connector includes an outwardly-facing interface connector portion, a first plurality of electrical contacts located on the interface connector region and a second plurality of electrical contacts opposite the interface connector portion wherein the second plurality of electrical contacts are each in communication with a corresponding electrical contact of the first plurality of electrical contacts. One or more extensions extend opposite from the interface connector region wherein a vertical thickness of the one or more extensions defines a printed circuit board edge-facing region. Also included is one or more connection features that are each attached to one of the one or more extensions wherein the one or more connection features facilitate coupling the electrical connector with a printed circuit board, and wherein an edge of the printed circuit board abuts the printed circuit board edge-facing region.

### CROSS-REFERENCE TO RELATED APPLICATIONS

This application makes reference to the following commonly owned U.S. patent applications, which are herein incorporated in their entirety for all purposes:

U.S. patent application Ser. No. 10/940,111 in the name of John A. Hamming, entitled “Cartridge Carrier;”

U.S. patent application Ser. No. 10/962,484 in the name of Patrick H. McCormack and John A Hamming, entitled “Lockable Ejection System and Method;”

U.S. patent application Ser. No. 11/182,483 in the name of Anthony E. Pione and Richard M. Andrews, entitled “Data Flow Control and Bridging Architecture Enhancing Performance of Removable Data Storage Systems;” and

U.S. patent application Ser. No. 11/183,143 in the name of Patrick H. McCormack, entitled “External Desktop Dock for a Cartridge-based Data Storage Unit.”

### BACKGROUND

As the value and use of information increases, individuals and businesses seek additional ways to process and store information. One aspect of this evolution has been a progressively growing demand for increased storage capacity in portable memory devices. With the advent of personal computers and workstations, it is often necessary to remove the medium on which digital data is stored. A user may desire to remove a storage medium to carry it to a different site and/or a different computer system. It may also be desirable to remove the storage medium to a secure location when the stored computer data is sensitive, secret, or a back-up copy is needed. One option is the use of hard disk drives contained in removable cartridges.

Removable hard disk drives are typically housed in a shell or cartridge having isolating materials to protect the hard disk drive from dirt or other contaminates, or from shock forces, such as a free fall onto a hard surface. Thus, a cartridge 100 (FIG. 1) may be a ruggedized container that houses a hard disk drive. The cartridge is then connected to a larger computer system or network via a carrier installed in a desktop or server system. The carrier typically includes interface and control circuits to operably connect the hard disk drive inserted into the carrier to the motherboard of the host desktop or server system. Either the original cartridge is reinserted or a different cartridge can be inserted back into the carrier installed in the desktop or server. This insertion/removal cycle may occur several times throughout the work day.

Each time the hard disk drive cartridge is inserted into the carrier, it must be electrically and logically interconnected with the host computer by way of a plurality of interfaces connectors. To that end, the carrier bridges the interface between the host computer and the removable hard disk drive. A hard disk drive typically supports a device interface and command set, such as the ATA protocol or SATA protocol.

Logically, the disk drive cartridge includes a plurality of electrical contacts that are capable of mating with a corresponding connector in the carrier. The mating of the contacts with the connector allows for the cartridge to be powered-up and for data-connectivity to occur. As the cartridge is typically handled by one or more persons, the cartridge electrical contacts are therefore in danger of electro-static discharge (ESD) through, for example, a person accidentally touching the contacts. ESD can potentially damage electronics contained in the cartridge as well as erase data stored on the cartridge hard disk drive.

Due to ESD, it is desirable to place the electrical contacts such that they are recessed into the body of the cartridge. By doing so, the possibility of a finger touching the contacts would be lessened. However, the placement of the contacts relative to the body of the cartridge is typically dictated by dimensions of the mating connector attached to a board contained in the carrier. That is, the connector is typically fastened to a face of a printed circuit board such that the side that connects with the cartridge contacts is placed to ensure a secure fit with the cartridge. This placement is typically defined by the connector depth that hangs off of the printed circuit board. Therefore, adjusting the cartridge contacts placement also necessitates an adjustment to the mating connector contained in the carrier. In addition, configuration of mating connectors found in the art limit the distance by which the connector within the cartridge can be recessed.

In view of the foregoing, it may be beneficial to provide an electrical connector that provides a secure fit between a cartridge and carrier yet still allows for the cartridge contacts to be recessed in the cartridge body in order to prevent accidental ESD damage.

The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated.

An embodiment by way of non-limiting example provides for an electrical connector that includes an outwardly-facing interface connector portion, a first plurality of electrical contacts located on the interface connector region and a second plurality of electrical contacts opposite the interface connector portion wherein the second plurality of electrical contacts are each in communication with a corresponding electrical contact of the first plurality of electrical contacts. One or more extensions extend opposite from the interface connector region wherein a vertical thickness of the one or more extensions defines a printed circuit board edge-facing region. Also included is one or more connection features that are each attached to one of the one or more extensions wherein the one or more connection features facilitate coupling the electrical connector with a printed circuit board, and wherein an edge of the printed circuit board abuts the printed circuit board edge-facing region.

Yet another embodiment by way of non-limiting example provides for an electrical connector that includes an interface connector portion that includes a first top region, a first bottom region, two opposing first side regions and an interface connector region that includes a first plurality of electrical contacts. A circuit board connector portion includes a second top region adjacent to the first top region, a second bottom region adjacent to the first bottom region, two opposing second side regions each adjacent to one of the two opposing first side regions and a circuit board connector region opposite the interface connector region wherein the circuit board connector region includes a second plurality of electrical contacts that are each in communication with a corresponding electrical contact of the first plurality of electrical contacts, and wherein a first thickness is defined between the second top region and the second bottom region. One or more extensions extend outward from the circuit board connector portion wherein the one or more extensions have a vertical thickness that is less than the first thickness to define a circuit-board facing surface. Also included are one or more projections that are each located on one of the one or more.

Another embodiment by way of non-limiting example provides for an electrical connector that includes an interface connector portion and a circuit board connector portion opposite the interface connector portion. Also included are a plurality of extensions extending from the circuit board connector portion wherein the circuit board connector portion includes a cutout defining a board-facing edge, whereby the interface connector portion extends beyond the edge of a printed circuit board when the circuit board connector portion is attached to the printed circuit board.

A final embodiment by way of non-limiting example provides for an electrical connector that has an interface connector portion that includes a first top region, a first bottom region, two opposing first side regions and an interface connector region that includes a plurality of electrical contacts. A circuit board connector portion includes a second top region adjacent to the first top region, a second bottom region adjacent to the first bottom region, two opposing second side regions each adjacent to one of the two opposing first side regions and a circuit board connector region opposite the interface connector region wherein the circuit board connector region includes a second plurality of electrical conducts that are each in communication with a corresponding electrical contact of the plurality of electrical contacts. Also included are two connection features on opposite ends of the circuit board connector region and each adjacent to one of the two opposing second side regions wherein the two connection features facilitate attaching the electrical connector to a printed circuit board such that an edge of the printed circuit board abuts the circuit board connector region.

In addition to the exemplary aspects and embodiments described above, further aspects and embodiments will become apparent by reference to the drawings and by study of the following descriptions.

### BRIEF DESCRIPTION OF THE DRAWINGS

Exemplary embodiments are illustrated in referenced figures of the drawings. It is intended that the embodiments and figures disclosed herein are to be considered illustrative rather than limiting.

FIG. 1 illustrates an embodiment of a removable cartridge containing a data storage system, in accordance with an exemplary embodiment;

FIGS. 2A-2B illustrate an embodiment of a cartridge carrier, in accordance with an exemplary embodiment;

FIG. 3 illustrates insertion of the removable cartridge into the cartridge carrier, in accordance with an exemplary embodiment;

FIG. 4 illustrates an internal view of the cartridge carrier; in accordance with an exemplary embodiment;

FIGS. 5A-5B illustrate a detailed view of the printed circuit board with the electrical connector of FIG. 4, in accordance with an exemplary embodiment;

FIGS. 6A-6B illustrate various isometric views of an electrical connector, in accordance with an exemplary embodiment;

FIG. 7 illustrates a plan view of an electrical connector, in accordance with an exemplary embodiment;

FIG. 8 illustrates a front elevation view of an electrical connector, in accordance with an exemplary embodiment;

FIG. 9A illustrates a side elevation view of an electrical connector, in accordance with an exemplary embodiment;

FIG. 9B illustrates a side elevation view of an electrical connector coupled with an edge of a printed circuit board, in accordance with an exemplary embodiment;

FIG. 10 illustrates a cross section of the electrical connector of FIG. 6A taken along line A-A, in accordance with an exemplary embodiment; and

FIG. 11 illustrates an isometric view of an electrical connector, in accordance with an exemplary embodiment; and

FIG. 12 illustrates a close-up view of the electrical connector of FIG. 11, in accordance with an exemplary embodiment.

### DETAILED DESCRIPTION

The following embodiments and aspects thereof are described and illustrated in conjunction with systems, apparatuses and methods which are meant to be exemplary and illustrative, not limiting in scope.

The claimed embodiments contemplate a recessed, extended length, thin profile SATA connector designed to operate with a cartridge-based data storage system (e.g., a cartridge containing a hard disk drive and other electronics). Since the connector has an extended length, the corresponding contacts of the cartridge can be placed at a corresponding depth inside the cartridge body. As a result, the cartridge contacts are effectively out of reach of a human finger and chances of accidental ESD damage are reduced. The extended length connector is accomplished, at least in part, by employing a connection mechanism that allows the connector to be coupled to, and extend from, an edge of a printed circuit board (PCB). In one preferred embodiment, the connection mechanism includes one or more extensions on a PCB-facing side of the connector and one or more projections on each of the extensions. The projections are mated with a corresponding hole in the PCB thus accomplishing the coupling of the connector with the PCB. In the context of the claimed embodiments, it should be understood that the phrase “coupled with” and phrases containing “coupled” and “with” are meant to imply that two or more bodies that are joined together in a semi-permanent fashion but can be physically separated without physical detriment to either body. Similarly, the phrase “coupled to” and phrases containing “coupled” and “to” are meant to convey two bodies that are joined together in a permanent fashion and can not be easily separated without some likelihood of damage to either body.

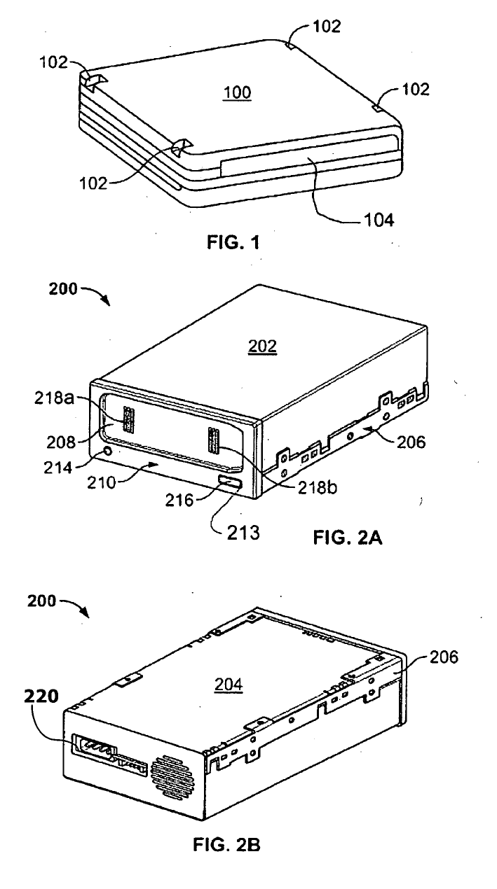

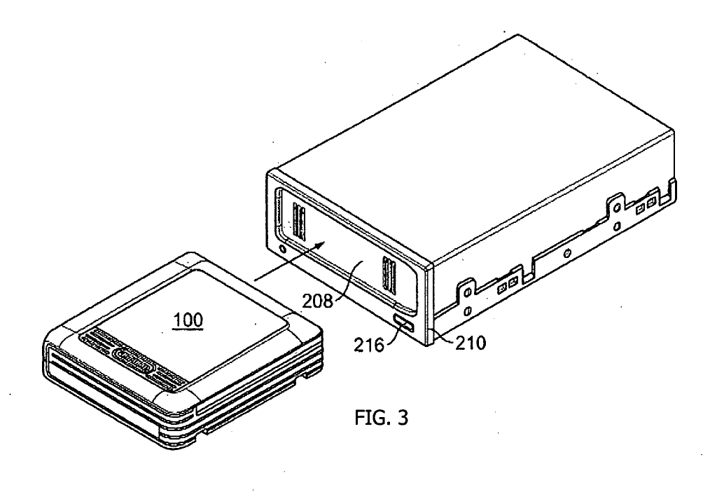

For didactic purposes, an embodiment of the present invention operates in connection with the removable cartridge system illustrated in FIGS. 1, 2A, 2B and 3. The present invention, however, can operate in connection with a vast array of removable media systems. FIG. 1 illustrates an embodiment of a removable cartridge. The cartridge 100 may be any shape or size necessary for its use. The cartridge 100 may have notches 102 and orientation tab channel 104 to assist in the positioning of the cartridge 100 in the carrier and to notify a user that the cartridge 100 is properly inserted into the carrier. FIG. 2A and 2B are diagrams of a cartridge carrier according to one implementation of the present invention. The cartridge carrier 200, in one implementation, is a docking mechanism into which the cartridge 100 is inserted. As discussed in more detail below, the cartridge carrier 200 provides the interconnection between the motherboard of the host computing device and the target hard disk drive 70 contained in the cartridge 100. The cartridge carrier 200 may have a top cover 202, a bottom cover 204, and a base 206 thereby forming an enclosure. The base 206 connects the bottom cover 204 and the top cover 202 and is positioned within the enclosure. The cartridge carrier 200 may be designed to fit into a 3.5 inch form factor for installation into a bay of a desktop or server box. The carrier 200 may be made of any dimensions necessary, but may have an outside dimension of about between 90-110 mm width, 30-50 mm height, and about 130-190 mm length. As FIG. 2B illustrates, the cartridge carrier 200 includes a connector assembly 220 to allow for a physical connection between the host computing device and the cartridge carrier electronics discussed below. Of course, other implementations are possible. For example, the carrier may be a stand-alone unit, such as a dock that is external from a host computing system.

The cartridge carrier 200, in one implementation, has an opening assembly 210 to provide access to the enclosure and to guide the cartridge 100 into the carrier. The opening assembly 210 may have a door 208, a light pipe opening 214, and an eject button 216. The opening assembly 210 may be contoured to the profile of the carrier 200, and may be larger in height and width than the carrier 200. The opening assembly 210 may be removably connected to the carrier 200 by any means such as snap fit, friction fit, attached with an adhesive, and the like. The door 208 may be designed to be spring closed when a cartridge is not present and may contain a plurality of risers 218a, 218b to contact the cartridge 100. The ridges reduce wear marks on the door and the cartridge 100. U.S. application Ser. Nos. 10/940,111 and 10/962,484 identified above, provide further details of the mechanical configuration and operation of the cartridge carrier system, such as the physical connection of the interface connectors between the data storage unit of the cartridge, upon insertion, to the corresponding interface connectors of the carrier.

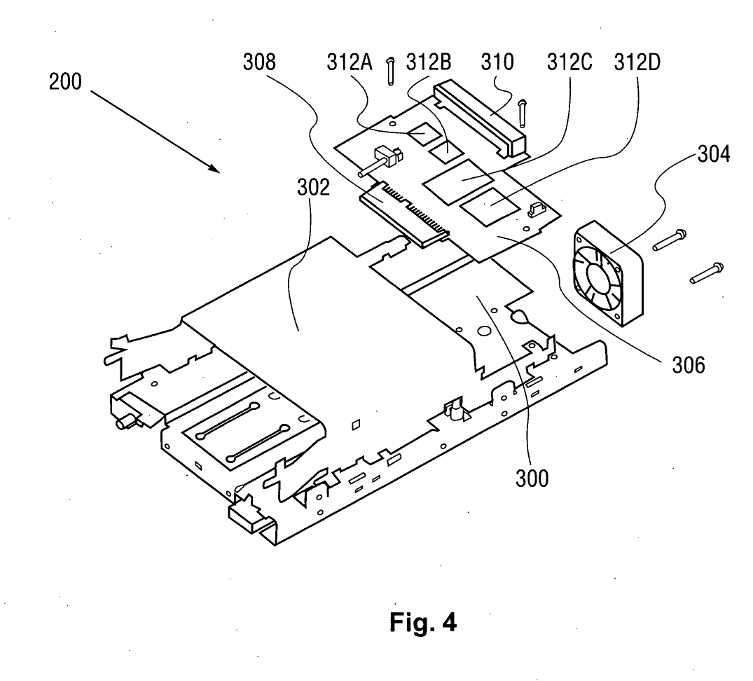

An electrical connector of the claimed embodiments will now be presented in detail. FIG. 4 illustrates an internal view of the cartridge carrier 200, in accordance with an exemplary embodiment. As can be seen, the outer casing of the carrier has been removed and what remains is a base support 300, cartridge guide/top support 302, a fan 304 and a PCB 306. For illustrative purposes only, the fan 302 and PCB 306 are depicted as floating. It should be understood that the fan 302 and PCB 306 are meant to be coupled with the cartridge carrier 200. PCB 306 further includes a first electrical connector 308, a second electrical connector 310 and processing electronics (312A, 312B, 312C, and 312D). In practice, the cartridge 100 (not shown) will mate with connector 308 when the cartridge is inserted into the cartridge carrier 200.

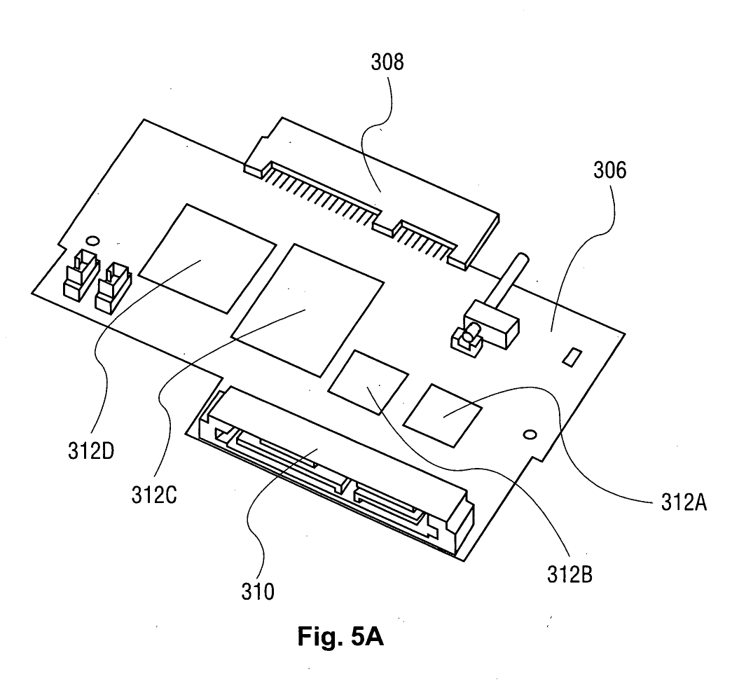

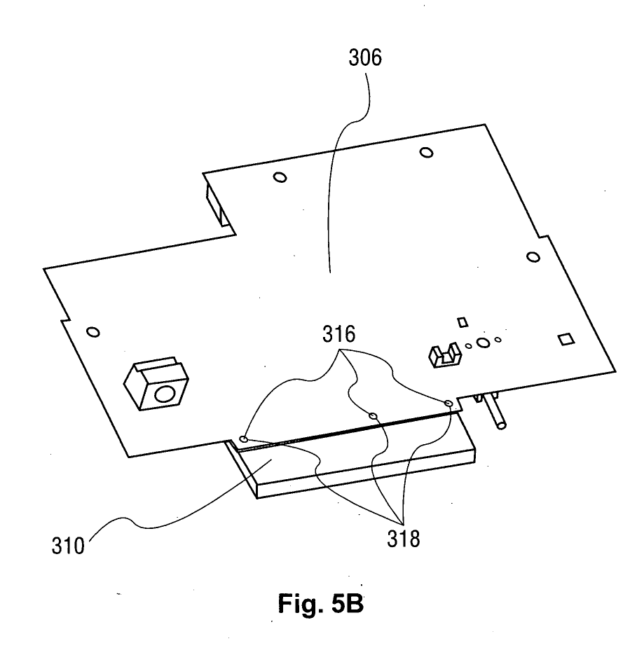

FIGS. 5A-5B illustrate a detailed view of the PCB 306 with the electrical connector 308 of FIG. 4, in accordance with an exemplary embodiment. Specifically, FIG. 5A illustrates a detailed top view of the PCB 306, while FIG. 5B illustrates a detailed bottom view of PCB 306. As can be seen, connector 308 “hangs” off, and extends from, the edge of the PCB 306. The connector 308 is attached to the PCB 306 via extensions (314) each of which have a corresponding projection (318) that is mated with a hole (320) in the PCB 306. While three sets of extensions 314, projections 318 and corresponding holes 320 are shown, it should be understood that the claimed embodiments can be practiced with just one set or multiple sets other than three sets.

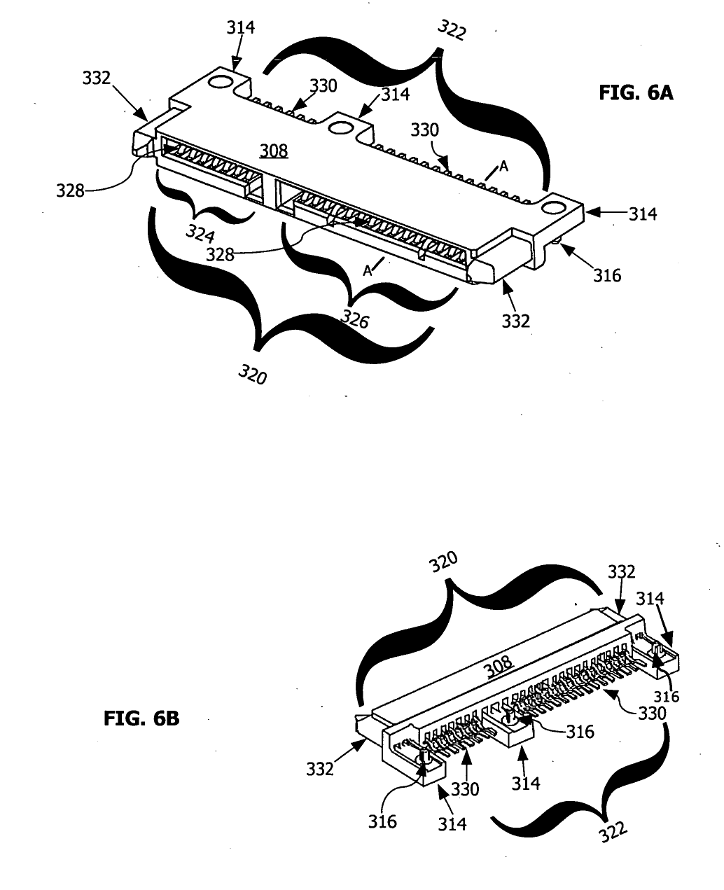

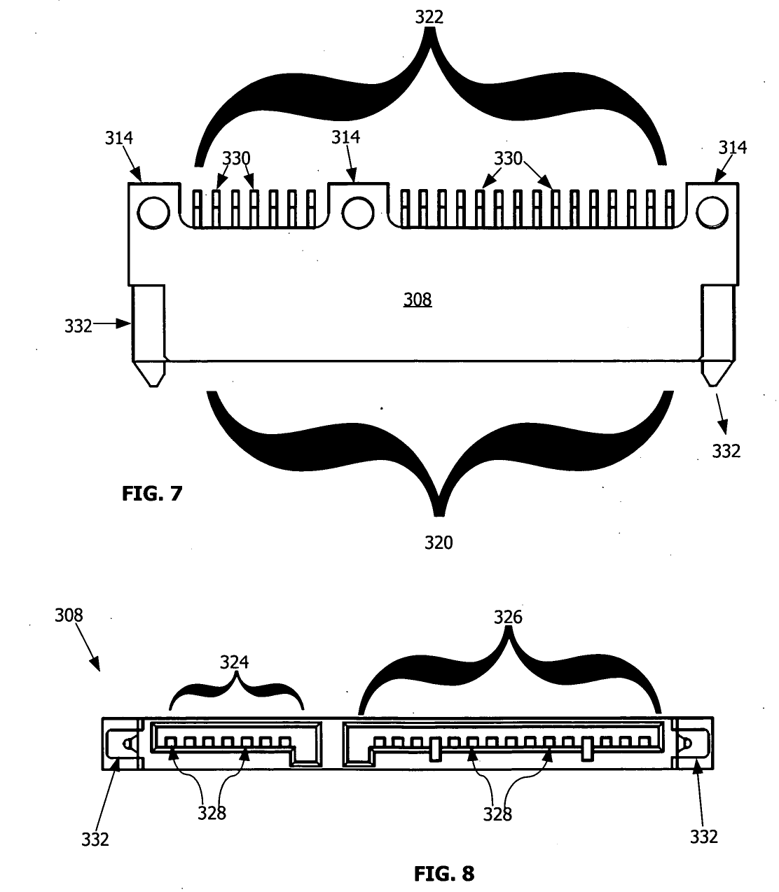

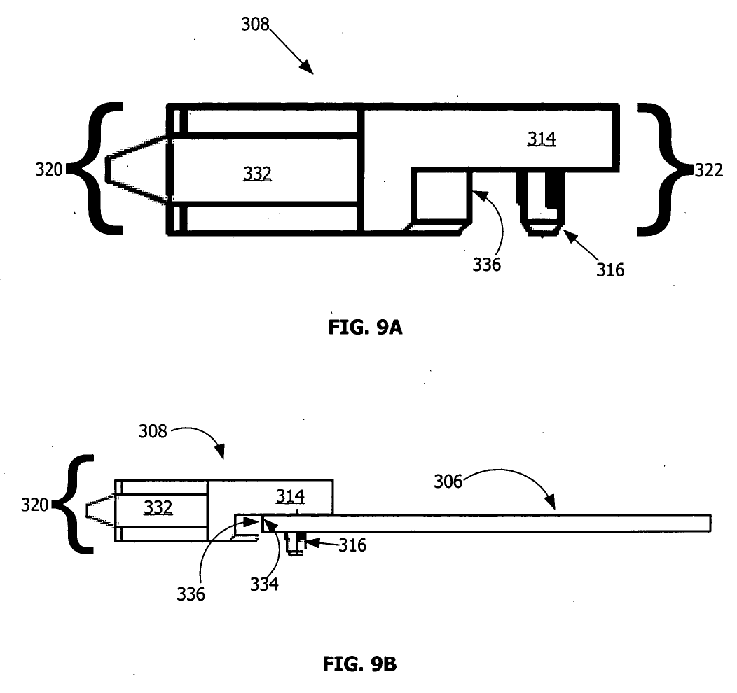

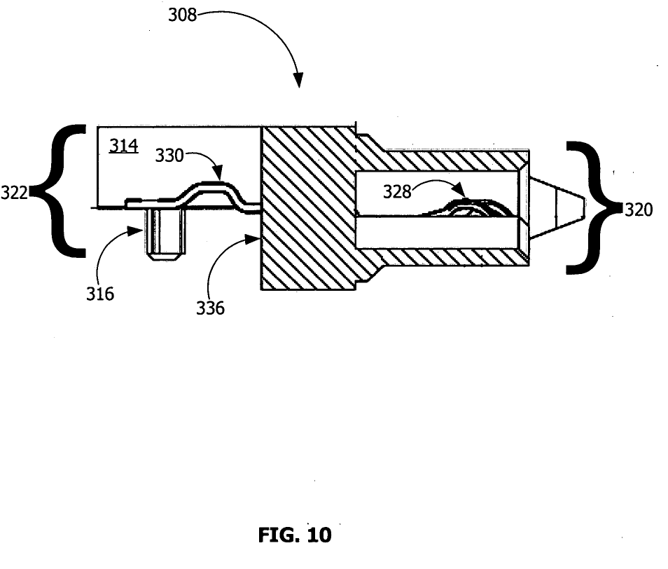

Various, detailed views of connector 308 will now be presented via FIGS. 6A-10. Specifically, FIGS. 6A-6B illustrate various isometric views, FIG. 7 illustrates a plan view, FIG. 8 illustrates a front elevation view, FIG. 9A illustrates a side elevation view, FIG. 9B illustrates a side elevation view of the electrical connector 308 coupled with an edge of a printed circuit board 306, and FIG. 10 illustrates a cross section of the electrical connector 308 of FIG. 6B taken along line A-A—all of which are in accordance with exemplary embodiments.

As previously alluded to, the connector 308 includes a side 320 that mates with a cartridge 100 (not shown) and a side 322 that is capable of being coupled with or coupled to a PCB such as PCB 306 of previous figures. In one preferred embodiment, side 320 takes the form of an SATA connector portion. Specifically, an SATA connector portion will typically include an SATA data section 324 and a power section 326. Both of the SATA section 324 and power section 326 includes a plurality of electrical contacts 328 that are each in communication with a corresponding contact of electrical contacts 330 which is demonstrated via the cross section of FIG. 10. Additionally, an SATA connector will also have a pair of guideposts 332 that help to ensure proper mating with a cartridge 100 (not shown). In one implementation, the length of the interface connecting region of the connector 308 defined by guideposts 332 can be extended as required to properly mate with a corresponding connector recessed within the cartridge 100. It should also be noted that once the connector 308 is coupled with the PCB 306, electrical contacts 330 are typically soldered to the printed circuit board.

Also previously indicated, connector 308 has extensions 314 each of which has a projection 316. When the connector is connected to a PCB 306, such as in FIG. 9B, the projection 316 is mated with a hole (not visible) in the PCB 306. It should be further noted that an edge 334 of the PCB 306 abuts the connector along region 336. As FIG. 9B illustrates, the interface connector region extends over the edge of the PCB 306, abutting against the outer edge of the PCB 306 at region 336. This configuration, in one implementation, enhances the structural integrity of the attachment between the connector 308 and the PCB 306. For example, the abutment between the connector 308 and the PCB 306 at region 336 reduces or eliminates the shear forces on the connection between the connector 308 and the PCB 306 at the projections 316 that could be caused when the cartridge 100 is inserted into the carrier 200. In an alternative embodiment, there are holes on the extensions where the projections normally are located and corresponding projections are located on the PCB. The projections on the PCB are then mated with the holes on the extensions. In another embodiment, the projections face upward and are mated to an underside of the PCB with corresponding holes. In yet another embodiment, the extensions extend to the side of the connector and the extensions are at the end of the extensions that terminate to the side of the connector.

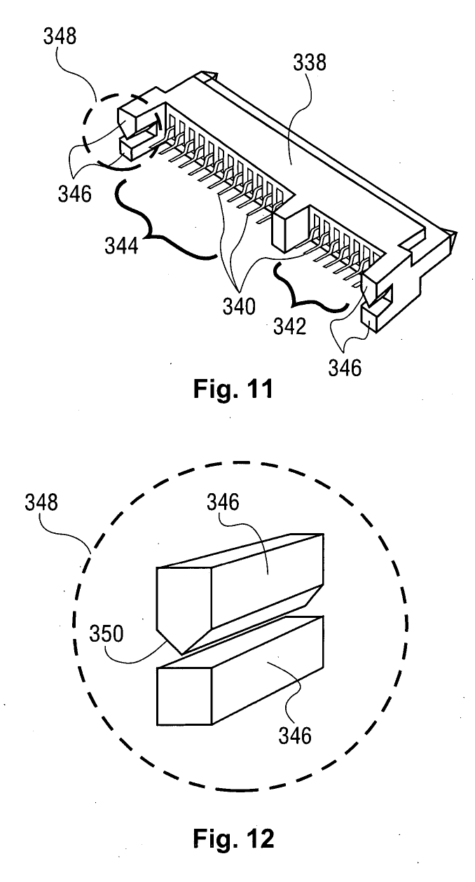

While the previously described embodiments of projections and mating holes are effective in coupling a connector to an edge of a PCB and thus allowing for a long profile SATA connector on the other side, other embodiments are envisioned to accomplish the same task. For example, FIG. 11 illustrates an isometric view of an electrical connector 338 and FIG. 12 illustrates a close-up view of the electrical connector of FIG. 11—both of which are in accordance with exemplary embodiments. Similar to the previous embodiments, connector 338 includes contacts 340 for a power section 342 and a data section 344. Also included are extensions 346. However, connector 338 employs pairs of extensions 346 that are vertically opposed. In reference to FIG. 12, one of the two extensions 346 further includes a crush rib 350 that faces the other extension 346 that does not have the crush rib. When the connector 338 is placed on an edge of a PCB, the edge is inserted between each pair of extensions 346 and the crush rib 350 deforms in a plastic-fashion such that the deformation ensures a tight coupling of the connector 338 with the PCB.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1-18. (canceled)

19. A docking apparatus for a cartridge containing a hard disk drive, comprising:
a frame;
an opening assembly operably attached to the frame and adapted to receive the cartridge;
a printed circuit board (PCB) mounted within the frame, the printed circuit board including one or more mounting holes;
an extended-length connector extending from a first edge of the printed circuit board and extending substantially toward the opening assembly;
a cartridge guide within the frame, the cartridge guide adapted to guide the cartridge toward the extended-length connector during insertion through the opening assembly;
wherein the extended-length connector comprises:
an interface connector portion having a first thickness, and a circuit board connector portion having a second thickness, the first thickness being greater than the second thickness to define a PCB-facing surface, wherein the circuit board connector portion comprises one or more extensions extending oppositely from the interface connector portion and one or more projections each extending from respective extensions and through a corresponding mounting hole of the one or more mounting holes of the printed circuit board.

20. The docking apparatus of claim 19 wherein the interface connector portion has a length that is configured to mate with a corresponding connector recessed in the cartridge.

21. The docking apparatus of claim 19 wherein the extended-length connector abuts against the first edge of the PCB at the PCB-facing surface.

22. The docking apparatus of claim 19 wherein the one or more extensions are first and second extensions.

23. The docking apparatus of claim 22 further comprising a third extension extending oppositely from the interface connector portion in-between the first and second extensions.

24. The docking apparatus of claim 23 further comprising:
two guideposts extending along opposite sides of the of interface connector portion; and
wherein the interface connector portion further comprises a serial advanced technology attachment connector region and a power connector region.

25. The docking apparatus of claim 19 further comprising first and second guideposts extending along opposing sides of the interface connector portion.

26. The docking apparatus of claim 24 wherein the interface connector portion further comprises a serial advanced technology attachment connector region and a power connector region.

27. An extended-length connector adapted to extend from a first edge of a printed circuit board (PCB), comprising:
an interface connector portion having a first thickness;
a circuit board connector portion having a second thickness, the first thickness being greater than the second thickness to define a PCB-facing surface;
wherein the circuit board connector portion comprises one or more extensions extending from the circuit board connector portion and one or more projections each extending from respective extensions and adapted to extend through a mounting hole of the PCB; and
wherein the interface connector portion has a length that is configured to mate with a corresponding connector recessed in a cartridge.

28. The docking apparatus of claim 27 wherein the one or more extensions are first and second extensions.

29. The docking apparatus of claim 28 further comprising a third extension extending from the circuit board connector portion in-between the first and second extensions.

30. The docking apparatus of claim 29 further comprising:
two guideposts extending along opposite sides of the of interface connector portion; and
wherein the interface connector portion further comprises an serial advanced technology attachment connector region and a power connector region.

31. The docking apparatus of claim 27 further comprising first and second guideposts extending along opposing sides of the interface connector portion.

32. The docking apparatus of claim 30 wherein the interface connector region further comprises a serial advanced technology attachment connector region and a power connector region.
